(19) United States
(12) Patent Application Publication
(10) Pub. No.: US 2023/0231723 A1
(43) Pub. Date: Jul. 20, 2023

(54) FAN EMOJI IDENTIFICATIONS

(71) Applicant: Emoji ID, LLC, Oakland, CA (US)

(72) Inventors: Naveen JAIN, Nashville, TN (US); Riccardo SPAGNI, Plettenburg (ZA)

(21) Appl. No.: 17/578,075

(22) Filed: Jan. 18, 2022

(51) Int. Cl. H04L 9/32; G06Q 50/00

(52) U.S. Cl. CPC H04L 9/3247; G06Q 50/01

(57) ABSTRACT

Implementations generally relate to fan emoji identifications. In some implementations, a method includes generating a primary emoji identifier (ID), wherein the primary emoji ID is digitally signed with a primary private encryption key, and wherein the primary emoji ID is associated with a primary user. The method further includes generating a splitter emoji, wherein the splitter emoji demarcates the primary emoji ID. The method further includes generating a secondary emoji identifier (ID), wherein secondary emoji ID is associated with a secondary user. The method further includes concatenating the primary emoji ID, the splitter emoji, and the secondary emoji ID, wherein the combination of the primary emoji ID and the secondary emoji ID provides an attestation of an affinity of the secondary user to the primary user.

### SUMMARY

Implementations generally relate to fan emoji identifications. In various implementations, a method includes generating a primary emoji identifier (ID), wherein the primary emoji ID is digitally signed with a primary private encryption key, and wherein the primary emoji ID is associated with a primary user. The method further includes generating a splitter emoji, wherein the splitter emoji demarcates the primary emoji ID. The method further includes generating a secondary emoji identifier (ID), wherein secondary emoji ID is associated with a secondary user. The method further includes concatenating the primary emoji ID, the splitter emoji, and the secondary emoji ID, wherein the combination of the primary emoji ID and the secondary emoji ID provides an attestation of an affinity of the secondary user to the primary user.

### BRIEF DESCRIPTION OF THE DRAWINGS

FIG. 1 is a block diagram of an example environment for providing fan emoji identifications, which may be used for implementations described herein.

FIG. 2 is a block diagram of an example network environment for providing fan emoji identifications, which may be used for implementations described herein.

FIG. 3 is an example flow diagram for providing fan emoji identifications, according to some implementations.

FIG. 4 is an example block diagram of a fan emoji ID, according to some implementations.

FIG. 5 is a block diagram of an example network environment, which may be used for some implementations described herein.

FIG. 6 is a block diagram of an example computer system, which may be used for implementations described herein.

### DETAILED DESCRIPTION

Implementations described herein provide fan emoji identifications. In various embodiments, the system generates a primary emoji ID for a primary user, such as a celebrity, and one or more secondary emoji IDs for one or more respective secondary users, which includes fans of the primary user (e.g., celebrity). As described in more detail herein, the system also generates fan emoji IDs for the secondary users, where each fan emoji ID includes the primary emoji ID associated with the primary user (e.g., celebrity), and a secondary emoji ID associated with a given secondary user (e.g., fan).

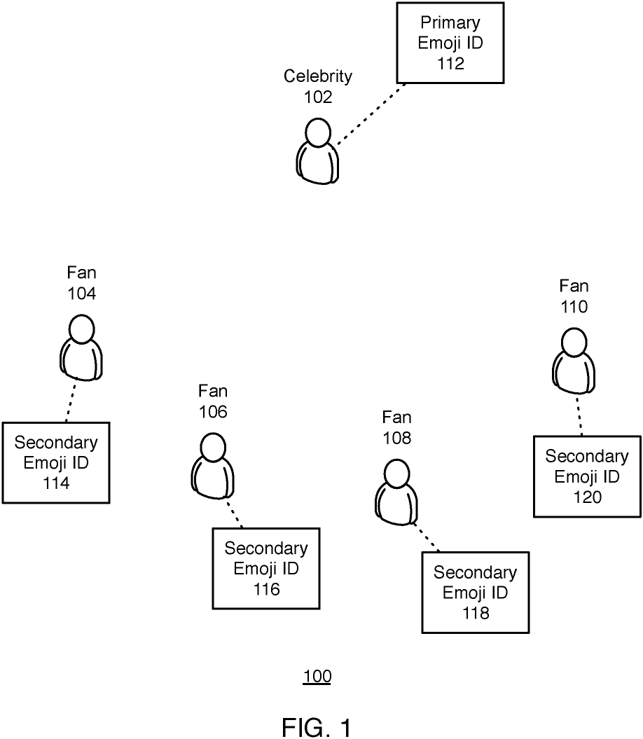

FIG. 1 is a diagram of an example environment 100 involving fan emoji identifications, which may be used for some implementations described herein. The following description provides an example context for various implementations described herein. As shown, a celebrity user 102, also referred to as a primary user, has a fan base that includes a fan 104, a fan 106, a fan 108, and a fan 110.

For ease of illustration, four fans are shown. The number of fans associated with celebrity 102 may vary, depending on the particular scenario. For example, each fan shown may represent hundreds, thousands, millions, or more fans. These fans may be physically located in countries around the world. These fans may follow celebrity 102 in various different social media platforms. In various implementations, the system enables celebrity 102 to communicate and interact with the celebrity’s fans via these social media platforms, as well as via other environments such as entertaining venues, etc.

As described in more detail herein, the system provides generates fan emoji IDs that associate a given primary emoji ID 112 with a set of secondary IDs 114, 116, 118, and 120 that identify fans 104, 106, 108, and 110, respectively. The fan emoji IDs facilitate the system in distinguishing between different types of or categories of fans. For example, fans may range from those who simply like the celebrity to fans who are aficionados or enthusiasts with respect to the celebrity. Fan emoji IDs enable the system to accurately distinguish different types or categories of fans in order to provide some fans (e.g., aficionados, enthusiasts, etc.) with special or privileged interaction, events, products, services, etc. The system accurately identifies particular fans based on their secondary emoji IDs contained in the fan emoji IDs.

While various implementations are described in the context the primary user being a celebrity, such as celebrity 102, primary users may also include users representing organizations such as sports teams. The specific types of primary users may vary depending on the implementations. In another example, some primary users may also include users representing entities or organizations such as name brand businesses and/or users representing popular products and/or services. As such, a given fan user may be a fan of multiple celebrities, sports teams, etc. Fan emoji IDs facilitate the system in associating fans with celebrities and entities, as well as tracking and managing such associations. The system accurately identifies particular celebrities or entities based on their primary emoji IDs contained in the fan emoji IDs.

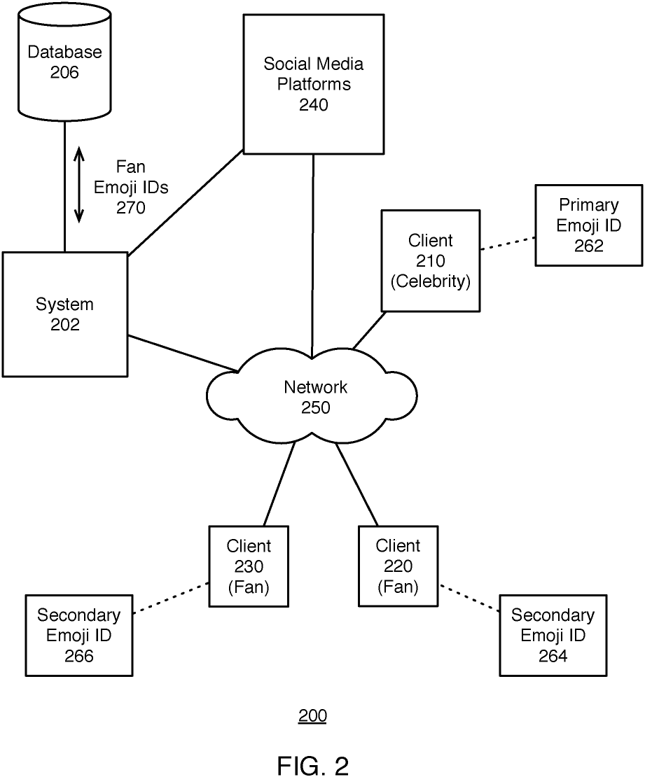

FIG. 2 is a block diagram of an example network environment 200 for providing fan emoji identifications, which may be used for implementations described herein. In some implementations, network environment 200 includes a system 202, which accesses a database 206. Network environment 200 also includes a client device 210 associated with a primary user, which is a celebrity in this example. Network environment 200 also includes client devices 220 and 230 associated with fan users. Client devices 210, 220, and 230 may communicate with system 202 and/or may communicate with each other directly or via system 202 and/or via one or more social media platforms 240. Network environment 200 also includes a network 250 through which system 202 and client devices 210, 220, and 230 communicate. Network 250 may be any suitable communication network such as a Wi-Fi network, Bluetooth network, the Internet, etc.

In the example scenario of FIG. 2, client 210 is a client device that is associated with a primary user (e.g., celebrity), and clients 220 and 230 are client devices that are associated with fans. In various implementations, as indicated above, the system generates a primary emoji ID 262 and associates primary emoji ID 262 with the primary user (e.g., celebrity) of client 210. The system also generates secondary emoji IDs 264 and 266, and associates these secondary emoji IDs 264 and 266 with respective secondary users (e.g., fans) of clients 220 and 230.

In various implementations, as indicated herein, system 202 generates fan emoji IDs 270 that uniquely associate primary emoji ID 162 with a different secondary emoji ID (e.g., secondary emoji IDs 264, 266, etc.). The system may store fan emoji IDs 270 in database 206 and/or in other suitable storage locations and fetch individual fan emoji IDs 270 as needed in order to provide special privileges to particular fans.

In various implementations, the system registers and indexes the fan emoji IDs containing primary and secondary emoji IDs. The system also separately registers and indexes each primary emoji ID and each secondary emoji ID. This enables the system to more efficiently manage all such emoji IDs. Example implementations directed to primary emoji IDs, secondary emoji IDs, and fan emoji IDs combining primary and secondary emoji IDs are described in more detail herein, in connection with FIG. 2, for example.

For ease of illustration, FIG. 2 shows one block for each of system 202, database 206, and shows three blocks for client devices 210, 220, and 230. Blocks 202 and 206 may represent multiple systems and network databases. Also, there may be any number of client devices. In other implementations, environment 200 may not have all of the components shown and/or may have other elements including other types of elements instead of, or in addition to, those shown herein.

While system 202 performs implementations described herein, in other implementations, any suitable component or combination of components associated with system 202 or any suitable processor or processors or networks including blockchain networks associated with system 202 may facilitate performing the implementations described herein.

In various implementations, an emoji ID includes a sequence of emojis. Emojis may be utilized to provide a user with an easy and intuitive way to identify a person or entity such as a celebrity or an entity or a fan. Emojis are miniature pictures that can be used to express thoughts, ideas, and concepts, that can be entered using a keyboard or software application, and can be entered without using alpha-numeric characters. Emojis are often easier to remember for a typical internet user than an alpha-numeric address. As such, a sequence of emojis rather than an alpha-numeric sequence may be better suited to ensuring that a user or customer can successfully access information pertaining to a celebrity, entity, or fan associated with a particular emoji ID.

In various implementations, the term “emoji sequence” may be used as an example of a type of ID that can be easy to remember and user-friendly. In some implementations, other sequences of characters that may include a mixture of emoji and non-emoji characters, as well as sequences that do not include emojis can also fall within the scope of the disclosure. As indicated herein, the use of emoji sequences may be a more intuitive and user-friendly way of accessing information pertaining to a particular celebrity, entity, or fan without having to remember a myriad of different addresses or identifiers that may rely on less intuitive alpha-numeric sequences. While various implementations are described herein in the context of emoji IDs, implementation may also apply to non-fungible tokens.

In various implementations, system 202 includes a blockchain network (not shown) having nodes, where each node maintains respective copies of a blockchain. The blockchain network may include hundreds or thousands of nodes. Also, the blockchain network may be a distributed peer-to-peer network. In some implementations, the blockchain network may implement known consensus algorithms to validate transactions submitted to the blockchain network. A verified transaction may include transferred cryptocurrency, contracts, records, or other information to be recorded to the blockchain. In some embodiments, multiple transactions are combined together into a block of data that is verified across a blockchain network. Once verified, this block of data can be added to an existing blockchain.

In various implementations, the blockchain includes a distributed ledger that maintains emoji identifications (IDs). As described in more detail herein, an emoji ID includes a sequence of emojis utilized to provide a user (e.g., celebrity, sports team, etc.) with an easy and intuitive way to identify fans. In various implementations, the blockchain of the system may verify an emoji ID by checking the emoji ID against the base node of the blockchain to determine the authenticity or validity of the emoji ID. Further implementations directed to emoji IDs are described in more detail herein.

In various implementations, emoji IDs may be associated with public and private keys. Public and private keys are an integral component of cryptocurrencies and other digital assets such as non-fungible token (NFTs) built on blockchain networks and are part of a larger field of cryptography known as public-key cryptography (PKC) or asymmetric encryption. The goal of PKC is to easily transition from a first state (e.g., a private key) to a second state (e.g., a public key), while making reversing the transition from the second state to the first state nearly impossible, and in the process, proving possession of a secret key without exposing that secret key. The product is subsequently a one-way mathematical function, which makes it ideal for validating the authenticity of transactions such as cryptocurrency transactions because possession of the first state such as the secret key cannot be forged. PKC relies on a two-key model, the public and private key. The general purpose of PKC is to enable secure, private communication using digital signatures in a public channel that is susceptible to potentially malicious eavesdroppers.

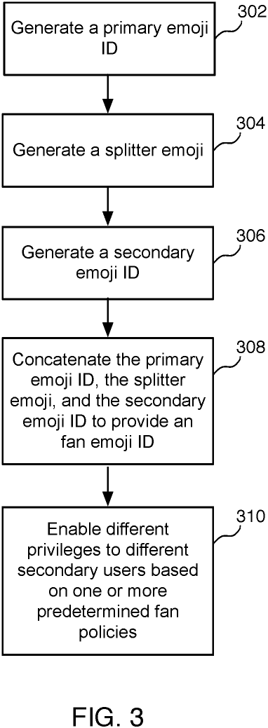

FIG. 3 is an example flow diagram for providing fan emoji identifications, according to some implementations. For ease of illustration, various example implementations herein are described in the context of a single primary user (e.g., celebrity) and a single secondary user (e.g., fan). These implementations also apply to each of multiple primary users, each having a fan base. These implementations also apply to each of multiple secondary users, each following their respective celebrity, entity, etc.

Referring to both FIGS. 2 and 3, a method is initiated at block 302, where a system such as system 102 generates a primary emoji identifier (ID). In various implementations, the primary emoji ID is digitally signed with a primary private encryption key. Also, the primary emoji ID is associated with a primary user. The digital signature ensures the authenticity of the primary emoji ID being associated with the primary user. In various implementations, the primary user is a celebrity. In various implementations, as indicated above, the primary user may be an entity.

As described in more detail herein, the primary user may be a person such as a celebrity who has a fan base and/or a person acting on behalf of an entity or object that has a fan base. For example, a celebrity may be a musician, actor, or other well-known individual with fans. An entity may be a sports team, a business, or other organization with fans. In some implementations, a fan may be a fan of an object, where the object may be a product such as a video game, a fictitious character from a book, television show, movie, etc. Any given person may represent or act on behalf of the entity or object. As such, the primary user may be associated with an entity or an object, in addition to an actual person such as a celebrity.

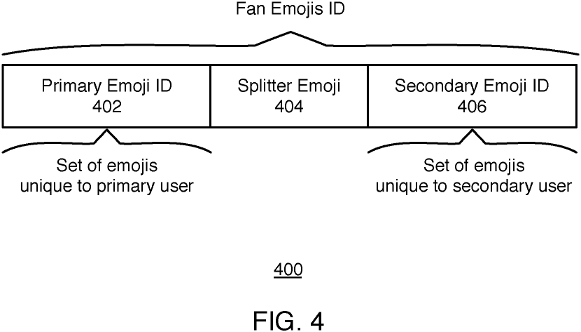

At block 304, the system generates a splitter emoji. In various implementations, the splitter emoji demarcates the primary emoji ID. In various implementations, after the system generates the splitter emoji, the system joins or concatenates the splitter emoji onto the primary emoji ID. Example implementations directed to the joining of the primary emoji ID, splitter emoji, and a secondary emoji ID are described below in connection with FIG. 4, for example.

At block 306, the system generates a secondary emoji identifier (ID). In various implementations, the secondary emoji ID is digitally signed with a secondary private encryption key. Also, the secondary emoji ID is associated with a secondary user. The digital signature ensures the authenticity of the secondary emoji ID being associated with the secondary user.

In various implementations, the secondary user is distinguished from the primary user in that the secondary user is a fan of the primary user, as described herein. In various implementations, a secondary emoji ID of a secondary user may be used for self-expression and self-identity with respect to the primary user, when the secondary emoji ID is associated with the primary emoji ID in an fan emoji ID, as described herein.

The associated fan emoji ID enables a fan to show their affinity towards the primary user (e.g., celebrity, sports team, etc.). This expression of affinity may be publically visible to the primary user and/or other fans on social media.

In various implementations, there may be any number of secondary users. For example, there may be a group of secondary users who are fans of a particular celebrity primary user. In some implementations, the secondary user may be a person who represents a group of fans. For example, a particular celebrity may have a particular group of fans belonging to an entity such as a fan organization. In this particular scenario, the secondary user ID may be associated with the entity, and the group of fans within the entity. This may be a scenario where a given group of fans have privileged access to offerings provided by the primary user (e.g., celebrity, etc.) by default by simply joining the entity. In some implementations, a given fan may be granted access to such offerings by simply being a member of the entity or may be granted such access independent of the entity if the fan is associated with a unique secondary emoji ID. In some implementations, a fan with a unique secondary emoji ID may be granted greater privileges than a fan who is merely associated with a secondary emoji ID via a fan entity. The particular privilege may vary, depending on the implementation.

At block 308, the system concatenates the primary emoji ID, the splitter emoji, and the secondary emoji ID to provide a fan emoji ID. In various implementations, the fan emoji ID, which includes a combination of the primary emoji ID and the secondary emoji ID provides an attestation of an affinity of the secondary user to the primary user. As such, the fan emoji ID may also be referred to as an attestation emoji ID or an affinity emoji ID.

In various implementations, the system generates a tertiary emoji identifier (ID) that includes the combination of the primary emoji ID, splitter emoji, and secondary emoji ID. The tertiary emoji ID may also be referred to as a fan emoji ID. In various implementations, the tertiary emoji ID is digitally signed with a tertiary private encryption key. The tertiary emoji ID, or fan emoji ID, provides an attestation of an affinity of the secondary user to the primary user. As described in more detail herein, in some implementations, the system may assign ownership of the tertiary private encryption key and the secondary encryption key to the same user or fan. In some implementations, the system may assign ownership of the tertiary private encryption key and the secondary encryption key to two different users or fans.

FIG. 4 is an example block diagram of a fan emoji ID, according to some implementations. Shown are a primary emoji ID 402, a splitter emoji 404, and a secondary emoji ID 406 concatenated together.

In various implementations, the system concatenates the splitter emoji to the end of the primary emoji ID, as shown. The system also concatenates the splitter emoji to the beginning of the secondary emoji ID. The primary emoji ID may also be referred to as a parent emoji ID, and the secondary emoji ID may also be referred to as a fan emoji ID or child emoji ID.

In various implementations, primary emoji ID 402 may include a predetermined number of emojis. For example, in various implementations, a primary emoji ID may have 1 to 5 emojis. Also, secondary emoji ID 406 may include a predetermined number of emojis. For example, in various implementations, a primary emoji ID may have 1 to 5 emojis. The number of emojis for each of primary emoji ID 402 and secondary emoji ID 406 may vary and even include more that 5 emojis, depending on the particular implementation. In an example scenario, a fan emoji ID may include, for example, the following string of emojis: Statue of Liberty emoji, baseball emoji, splitter emoji, rocket ship emoji, moon emoji, or [symbol] ). In this example, the primary emoji ID includes the Statue of Liberty emoji and the baseball emoji, or [symbol] Here, the primary emoji ID may be associated with a particular baseball team such as The New York Yankees™, for example. In this example, the splitter emoji is a plus sign, or +). The secondary emoji ID (e.g., rocket ship emoji, moon emoji, or [symbol] ) is associated with a particular secondary user or fan. The splitter emoji demarcates the primary and secondary emoji IDs. In this example scenario, a fan has purchased and owns the secondary emoji ID. The fan has also purchased and owns the fan emoji ID, which includes the primary emoji ID, the splitter emoji, and the secondary emoji ID). The fan emoji ID outwardly expresses the fan’s love, fandom, affinity, etc. for the primary user (e.g., sports team) who owns the primary emoji ID.

In various implementations, the system may generate multiple different fan emoji IDs for a given fan that has different affinities. This may be a scenario where, for example, the same fan purchases different fan emoji IDs for different celebrities and/or entities and/or objects, etc., for which the fan has love, fandom, affinities, etc. The different fan emoji IDs may share the same secondary emoji ID associated with the same fan and yet have different primary emoji IDs associated with different celebrities, entities, objects, etc. For example, the system may generate a first fan emoji ID (e.g., Statue of Liberty emoji, baseball emoji, splitter emoji, rocket ship emoji, and moon emoji, or [symbol] ). The system may generate a second fan emoji ID for the same fan (e.g., crown emoji, bee emoji, splitter emoji, rocket ship emoji, and moon emoji, or [symbol] ). Here, the primary emoji ID (e.g., crown emoji, bee emoji, or [symbol] )may be associated with a particular celebrity. The system may generate a third fan emoji ID for the same fan (e.g., hamburger emoji, French fries emoji, splitter emoji, rocket ship emoji, and moon emoji, or [symbol] ). Here, the primary emoji ID (e.g., hamburger emoji, French fries emoji, or [symbol] ) may be associated with a particular restaurant or even object. For example, the object may be a particular product (e.g., meal, etc.) sold by a particular celebrity or entity (e.g., restaurant, etc.). The splitter emoji may be the same or optionally different for each fan emoji ID, depending on the particular implementation. Here, the different fan emoji IDs outwardly expresses the fan’s love, fandom, affinity, etc. for the different primary users (e.g., sports team, celebrity, restaurant, etc.) who own the respective primary emoji IDs.

In some implementations, the splitter emoji functions not only as demarcation of the primary emoji ID but also as a demarcation of the secondary emoji ID. By demarcating the secondary emoji ID, the splitter emoji indicates to the system that system is reading the fan emoji ID, which includes a secondary emoji ID that identifies the associated fan.

While some implementations of splitter emoji 404 are described herein in the context of a single emoji, in some implementations, there may be some scenarios where a group of splitter emojis demarcates the primary emoji ID. For example, in some implementations, the number of splitter emotions and/or the type of one or more of the splitter emojis may indicate fan status levels, within which some fans may enjoy greater privileges than fans with lower fan status.

At block 310, the system enables different privileges to different secondary users (e.g., fans) based on one or more predetermined fan policies. For example, a fan policy may be to provide some privileges to certain categories of fans based on fan status. In various implementations, the system associates a fan status to the secondary emoji ID. The system may establish different levels of fan status. The fan status levels may range from a normal fan status to heightened fan status (e.g., super fan status, etc.). The particular levels and number of levels may vary, depending on the implementation.

In various implementations, the fan status associated with a given fan may be based on various factors. A given fan could earn a higher-level fan status via particular activities. For example, the system may promote a given fan to a higher-level fan status if the user demonstrates certain levels of engagement on social media with respect to the celebrity. In another example, given fan could earn a higher-level fan status via particular purchases. For example, system may promote a given fan to a higher-level fan status if the user purchases a secondary emoji ID, or purchases a particular type of secondary emoji ID. Secondary emoji IDs with higher-level fan status may simply cost more.

The system also associates one or more privileges with the secondary emoji ID based on the fan status. One type of secondary emoji ID may be for specific privileges. For example, some secondary emoji IDs may have a fan status that allows access to particular merchandise not offered to the general public. Some secondary emoji IDS may have a fan status that allows for certain interactions with the primary user. For example, some fans may have backstage access at certain concerts based on their fan status associated with their secondary emoji IDs. Some fans may have access to special events based on fan status associated with their secondary emoji IDs. Such special events my include online or social media live discussions with the primary user.

In some implementations, a privilege may be for the system to prominently display the secondary emoji IDs on one or more of the primary user’s pages on social media or other online platforms. This gives such fans recognition and high visibility to the celebrity as well as to other fans. In some implementations, the system may display different fans of different fan status with different levels visibility. For example, the system may display secondary emoji IDs with high fan status with higher visibility than other secondary emoji IDs having lower fan status.

In various implementations, when a given fan engages with social media in connection with a given primary user, the system detects the secondary emoji ID in association with a social media user interface. The system validates the secondary emoji ID. The system performs one or more predetermined actions based on the secondary emoji ID. In various implementations, the predetermined actions performed by the system may be based the fan status associated with the secondary emoji ID. For example, upon detection of secondary emoji ID, the system may access the database to determine and unlock particular offers or privileges described herein.

In various implementations, the system may use fan emoji IDs in a recursive manner, where the system gives a secondary emoji ID the same status as a primary emoji ID. For example, the system may create fan emoji IDs on behalf of a baseball team (e.g., The New York Yankees™) for each of their players and staff members. Each secondary emoji ID may function as a primary emoji ID for the fans of that of a player or staff member, etc. An example resulting fan emoji ID may be: [primary emoji ID 1][splitter emoji 1][secondary emoji ID 1][splitter emoji 2][secondary emoji ID 2], where the combination of [primary emoji ID 1][splitter emoji 1][secondary emoji ID 1] functions as a second primary emoji ID, which may be referred to as [primary emoji ID 2]. As such, the entire string (e.g., primary emoji ID 1, splitter emoji 1, secondary emoji ID 1, splitter emoji 2, secondary emoji ID 2) is not only a fan emoji ID associated with the baseball team (e.g., associated with primary emoji ID 1)] but is also a fan emoji ID associated with the player (e.g., associated with primary emoji ID 2). In various implementations, the splitters emojis are unique in order to differentiate the levels of fan emoji IDs. In the example above, splitter emoji 1 demarcates primary emoji ID 1 and secondary emoji ID 1. Splitter emoji 2 demarcates secondary emoji ID 1 and secondary emoji ID 2. This can be repeated indefinitely. In various implementations, not all fan emoji IDs received given this privilege, only a select subset. The number of different levels may vary, depending on the particular implementation. The following is an example of a recursive fan emoji ID (e.g., Statue of Liberty emoji, baseball emoji, plus sign splitter emoji, baseball emoji, person emoji, square splitter emoji, rocket ship emoji, moon emoji, or [symbol] ). Here, the fan emoji ID (e.g., [symbol] )outwardly expresses the fan’s love, fandom, affinity, etc. for a baseball player (e.g., [symbol] ) who owns the respective primary emoji ID 2.

In various implementations, the secondary emoji ID is different from the fan emoji ID, where the fan emoji ID includes the secondary emoji ID (e.g., primary emoji ID, splitter emoji, secondary emoji ID). For example, the primary emoji ID may be Statue of Liberty emoji, baseball emoji, or [symbol] . The splitter emoji may be a plus sign, or +. The secondary emoji ID may be red heart emoji, monkey face emoji, or [symbol] The primary emoji ID (e.g., Statue of Liberty emoji, baseball emoji, or [symbol] ), the fan emoji ID (e.g., Statue of Liberty emoji, baseball emoji, +, red heart emoji, monkey face emoji, or [symbol] and the secondary emoji ID (e.g., red heart emoji, monkey face emoji, or [symbol] ) are three completely independent emoji IDs, owned by different people. For example, in some implementations, the primary emoji ID may be owned by the primary user (e.g., sports team). The secondary emoji ID may be owned by a secondary user or fan (e.g., Charlie). The fan emoji ID may be owned by the same secondary user or fan (e.g., Charlie). In some implementations, there may be a scenario where the secondary emoji ID is owned by the secondary user or fan (e.g., Charlie), and where the fan emoji ID is owned by another secondary user or fan (e.g., Bob).

In various implementations, there may be private key that is associated with the primary emoji ID. There may be a separate private key that is associated with the entirety of the fan emoji ID. There may be yet another separate private key that is associated with the secondary emoji ID. As such, owning the secondary emoji ID would not give the fan automatic ownership or fan status to the primary emoji ID by means of owning the fan emoji ID.

Although the steps, operations, or computations may be presented in a specific order, the order may be changed in particular embodiments. Other orderings of the steps are possible, depending on the particular embodiment. In some particular embodiments, multiple steps shown as sequential in this specification may be performed at the same time. Also, some embodiments may not have all of the steps shown and/or may have other steps instead of, or in addition to, those shown herein.

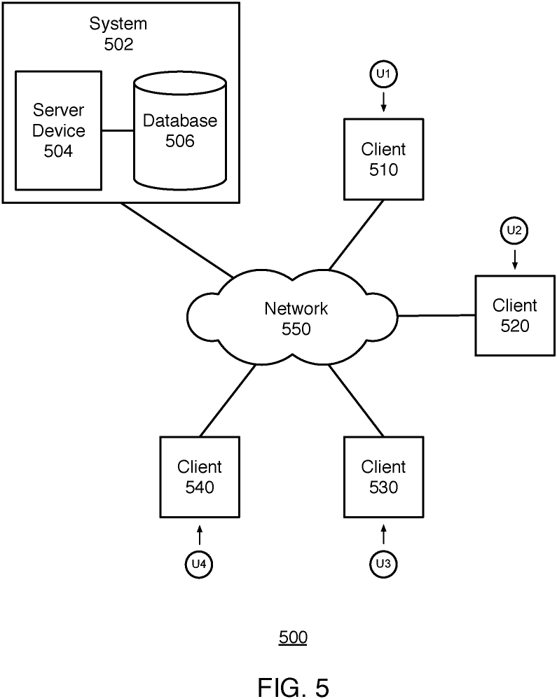

FIG. 5 is a block diagram of an example network environment 500, which may be used for some implementations described herein. In some implementations, network environment 500 includes a system 502, which includes a server device 504 and a database 506. For example, system 502 may be used to implement system 202 of FIG. 2, as well as to perform implementations described herein. Network environment 500 also includes client devices 510, 520, 530, and 540, which may communicate with system 502 and/or may communicate with each other directly or via system 502. Network environment 500 also includes a network 550 through which system 502 and client devices 510, 520, 530, and 540 communicate. Network 550 may be any suitable communication network such as a Wi-Fi network, Bluetooth network, the Internet, etc.

For ease of illustration, FIG. 5 shows one block for each of system 502, server device 504, and network database 506, and shows four blocks for client devices 510, 520, 530, and 540. Blocks 502, 504, and 506 may represent multiple systems, server devices, and network databases. Also, there may be any number of client devices. In other implementations, environment 500 may not have all of the components shown and/or may have other elements including other types of elements instead of, or in addition to, those shown herein.

While server 504 of system 502 performs implementations described herein, in other implementations, any suitable component or combination of components associated with server 502 or any suitable processor or processors associated with server 502 may facilitate performing the implementations described herein.

In the various implementations described herein, a processor of system 502 and/or a processor of any client device 510, 520, 530, and 540 cause the elements described herein (e.g., information, etc.) to be displayed in a user interface on one or more display screens.

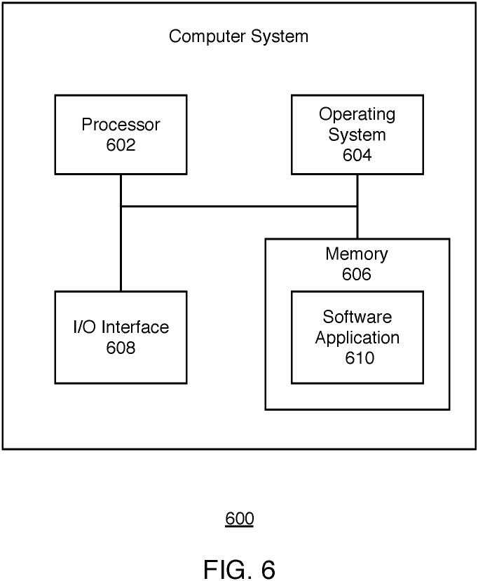

FIG. 6 is a block diagram of an example computer system 600, which may be used for implementations described herein. For example, computer system 600 may be used to implement server device 504 of FIG. 5 and/or system 202 of FIG. 2, as well as to perform implementations described herein. Computer system 600 is operationally coupled to one or more processing units such as processor 602, a memory 604, and a bus 606 that couples to various system components, including processor 602 and memory 604. Bus 606 represents one or more of any of several types of bus structures, including a memory bus, a memory controller, a peripheral bus, an accelerated graphics port, a processor or local bus using any of a variety of bus architectures, etc. Memory 604 may include computer readable media in the form of volatile memory, such as a random access memory (RAM) 608, a cache memory 610, and a storage unit 612, which may include non-volatile storage media or other types of memory. Memory 604 may include at least one program product having a set of at least one program code module such as program code 614 that are configured to carry out the functions of implementations described herein when executed by processor 602. Computer system 600 may also communicate with a display 616 or one or more other external devices 618 via input/output (I/O) interface(s) 620. Computer system 600 may also communicate with one or more networks via network adapter 622. In other implementations, computer system 600 may not have all of the components shown and/or may have other elements including other types of elements instead of, or in addition to, those shown herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various implementations of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
one or more processors; and
logic encoded in one or more non-transitory computer-readable storage media for execution by the one or more processors and when executed operable to cause the one or more processors to perform operations comprising:
generating a primary emoji identifier (ID), wherein the primary emoji ID is digitally signed with a primary private encryption key, and wherein the primary emoji ID is associated with a primary user;
generating a splitter emoji, wherein the splitter emoji demarcates the primary emoji ID;
generating a secondary emoji identifier (ID), wherein secondary emoji ID is associated with a secondary user; and
concatenating the primary emoji ID, the splitter emoji, and the secondary emoji ID, wherein the combination of the primary emoji ID and the secondary emoji ID provides an attestation of an affinity of the secondary user to the primary user.

2. The system of claim 1, wherein the primary user is a celebrity.

3. The system of claim 1, wherein the secondary user is a fan of the primary user.

4. The system of claim 1, wherein the splitter emoji is concatenated to the end of the primary emoji ID.

5. The system of claim 1, wherein the splitter emoji is concatenated to the beginning of the secondary emoji ID.

6. The system of claim 1, wherein the logic when executed is further operable to cause the one or more processors to perform operations comprising:
associating a fan status to the secondary emoji ID; and
associating one or more privileges with the secondary emoji ID based on the fan status.

7. The system of claim 1, wherein the logic when executed is further operable to cause the one or more processors to perform operations comprising:
detecting the secondary emoji ID in association with a social media user interface;
validating the secondary emoji ID; and
performing one or more predetermined actions based on the secondary emoji ID.

8. The system of claim 1, wherein the secondary emoji ID is digitally signed with a secondary private encryption key.

9. A computer-implemented method for providing fan emoji identifiers, the method comprising:
generating a primary emoji identifier (ID), wherein the primary emoji ID is digitally signed with a primary private encryption key, and wherein the primary emoji ID is associated with a primary user;
generating a splitter emoji, wherein the splitter emoji demarcates the primary emoji ID;
generating a secondary emoji identifier (ID), wherein secondary emoji ID is associated with a secondary user; and
concatenating the primary emoji ID, the splitter emoji, and the secondary emoji ID, wherein the combination of the primary emoji ID and the secondary emoji ID provides an attestation of an affinity of the secondary user to the primary user.

10. The method of claim 9, wherein the primary user is a celebrity.

11. The method of claim 9, wherein the secondary user is a fan of the primary user.

12. The method of claim 9, wherein the splitter emoji is concatenated to the end of the primary emoji ID.

13. The method of claim 9, wherein the splitter emoji is concatenated to the beginning of the secondary emoji ID.

14. The method of claim 9, further comprising:
associating a fan status to the secondary emoji ID; and
associating one or more privileges with the secondary emoji ID based on the fan status.

15. The method of claim 9, further comprising:
detecting the secondary emoji ID in association with a social media user interface;
validating the secondary emoji ID; and
performing one or more predetermined actions based on the secondary emoji ID.

16. The method of claim 9, wherein the secondary emoji ID is digitally signed with a secondary private encryption key.

17. A non-transitory computer-readable storage medium with program instructions stored thereon, the program instructions when executed by one or more processors are operable to cause the one or more processors to perform operations comprising:
generating a primary emoji identifier (ID), wherein the primary emoji ID is digitally signed with a primary private encryption key, and wherein the primary emoji ID is associated with a primary user;
generating a splitter emoji, wherein the splitter emoji demarcates the primary emoji ID;
generating a secondary emoji identifier (ID), wherein secondary emoji ID is associated with a secondary user;
concatenating the primary emoji ID, the splitter emoji, and the secondary emoji ID; and
generating a tertiary emoji identifier (ID), wherein the tertiary emoji ID is digitally signed with a tertiary private encryption key, wherein the tertiary emoji ID comprises a combination of the primary emoji ID and the secondary emoji ID, and wherein the tertiary emoji ID provides an attestation of an affinity of the secondary user to the primary user.

18. The computer-readable storage medium of claim 17, wherein the primary user is a celebrity.

19. The computer-readable storage medium of claim 17, wherein the secondary user is a fan of the primary user.

20. The computer-readable storage medium of claim 17, wherein tertiary emoji ID is associated with a tertiary user.
